(19) United States
(12) Patent Application Publication
(10) Pub. No.: US 2026/0107920 A1
(43) Pub. Date: Apr. 23, 2026

(54) Animal Identification Tag

(71) Applicant: SHEARWELL DATA LIMITED, Minehead Somerset (GB)

(72) Inventor: Sam WEBBER, Minehead Somerset (GB)

(73) Assignee: SHEARWELL DATA LIMITED, Minehead Somerset (GB)

(21) Appl. No.: 19/117,717

(22) PCT Filed: Oct. 2, 2023
(86) PCT No.: PCT/EP2023/077204

§ 371 Date: Apr. 2, 2025

(30) Foreign Application Priority Data
Oct. 3, 2022 (GB) 2214525.4

(51) Int. Cl. A01K 11/00

(52) U.S. Cl. CPC A01K 11/001

(57) ABSTRACT

An animal identification tag includes a female engagement portion and a male engagement portion having a tip, the female engagement portion being configured to receive and retain the tip. The tip comprises a body formed of a first material, the body including one or more openings that are filled with a second material, such that a first portion of an outer surface of the tip is formed by the first material, and a second portion of the outer surface of the tip is formed by the second material. The first material is harder than the second material.

### FIELD OF THE INVENTION

The present invention relates to an animal identification tag, in particular to an animal identification tag having male and female parts that are engageable with one another.

### BACKGROUND

It is well known in the field of animal identification to provide an identification tag, typically attached to the animal's ear. Such tags may comprise two parts (such as a male part and female part) which interlock with one part passing through the animal's ear. Alternatively a tag may be formed with a flexible connection between the two interlocking parts, i.e. as a single unit.

In order to attach tags to an animal, an applicator is used which typically drives a spiked male part of the tag through the animal's ear to engage with a female part of the tag on the other side to securely affix the tag to the animal.

The present invention has been devised in light of the above considerations.

### SUMMARY OF THE INVENTION

At its most general, the present invention provides an animal identification tag having male and female parts which are engageable with one another, where a tip of the male part includes a structure with two materials, one material being harder (e.g. less flexible) than the other. The combination of one harder and one softer (e.g. more flexible or elastic) material in the tip of the male part may facilitate attaching the tag to an animal. In particular, the harder material in the tip may facilitate piercing the animal's ear, whilst the softer material may enable the tip to flex or deform to facilitate insertion of the tip into the female part of the tag.

According to a first aspect of the invention, there is provided an animal identification tag comprising: a first part comprising a female engagement portion; and a second part comprising a male engagement portion having a tip, wherein the female engagement portion is configured to receive and retain the tip; wherein the tip comprises a body formed of a first material, the body including one or more openings that are filled with a second material, such that a first portion of an outer surface of the tip is formed by the first material, and a second portion of the outer surface of the tip is formed by the second material; wherein the first material is harder than the second material.

Thus, in use, the tip of the male engagement portion may be inserted through a part (e.g. an ear) of an animal and into the female engagement portion of the tag. In this manner, the part of the animal may be located between the first and second parts of the tag. The tip of the male engagement portion is then retained in the female engagement portion, so that the tag is secured to the animal. This may avoid the tag accidentally falling off or being tampered with once the tag has been attached to the animal.

The tip of the male engagement portion may have any suitable shape. For example, the tip of the male engagement portion may be pointed (e.g. spike-shaped), to facilitate inserting the male engagement portion through the animal's ear.

The body of the tip is formed of a first, harder (e.g. less flexible) material, whilst the one or more openings in the body are filled with a second less hard (e.g. softer or more flexible) material. Thus, the first portion of the outer surface of the tip (made of the first material), is harder than the second portion of the outer surface of the tip (made of the second material). The first portion of the outer surface of the tip may thus provide a relatively hard surface on the tip which may facilitate passage of the tip through a part (e.g. ear) of the animal. The second portion of the outer surface may be relatively flexible and deform more easily, providing the tip with a certain amount of flexibility. This may facilitate inserting the tip into the female engagement portion, as it may enable parts of the tip to be compressed as it is pushed into the female engagement portion. In particular, as the female engagement portion is configured to retain the tip, there may typically be a tight fit between the tip and the female engagement portion, such that the tip's ability to deform (e.g. compress) during insertion into the female engagement portion may facilitate attaching the tag to the animal.

The body may be formed of a single piece of material. The one or more openings in the body may be in the form of apertures and/or cavities in the outer surface of the body. The second material filling the one or more openings may be flush with the outer surface of the body. In this manner, the tip may have a smooth outer surface, i.e. the first and second portions of the outer surface of the tip may together form a smooth outer surface of the tip.

The female engagement portion is configured to receive the tip of the male engagement portion, and to retain the tip of the male engagement portion when the tip is received in the female engagement portion. In other words, the female engagement portion may be configured to prevent the tip of the male engagement portion from being removed (e.g. pulled out) from the female engagement portion after the tip has been received in the female engagement portion. Thus, the shapes of the tip of the male engagement portion and the female engagement portion may be adapted to one another, so that the tip of the male engagement portion is reliably retained in the female engagement portion. This may ensure that, once the tag has been attached to an animal, the tag cannot be removed and applied to another animal. Accordingly, the tag of the invention may prevent tampering with animal identification tags.

The female engagement portion may include any suitable structure or mechanism for retaining the tip of the male engagement portion following its insertion. For example, the female engagement portion may comprise a locking part configured to retain the tip of the male engagement portion following insertion of the tip into the female engagement portion.

In some embodiments, the female engagement portion may comprise a receptable for receiving the tip of the male engagement portion. The receptable may have an opening, with one or more petals arranged around an edge of the opening. The one or more petals may be configured (e.g. shaped) to allow the tip of the male engagement portion to be inserted into the receptacle via the opening in one direction, and to prevent the tip from being withdrawn from the receptacle in a second, opposite direction. For example, the one or more petals may include a sliding surface over which the outer surface of the tip is configured to slide when the tip is inserted through the opening, and a blocking surface configured to engage a proximal end of the tip once the tip is fully inserted through the opening, wherein engagement between the blocking surface and the proximal end of the tip blocks the tip from being withdrawn through the opening. In some cases, the one or more petals may be configured to bend or flex when the tip is inserted into the opening, to facilitate insertion of the tip into the opening.

The receptacle of the female engagement portion may be configured contain (e.g. enclose or encapsulate) the tip of the male engagement portion once the tip has been inserted into the receptacle. In this manner, even if the tip becomes separated from the rest of the male engagement portion (e.g. due to breaking of the male engagement portion), the tip is prevented from falling out of or being removed from the receptacle. As a result, once the tag has been attached to a first animal, the tag cannot be reused on another animal. For example, the receptacle may have a closed end (opposite its opening) to prevent the tip from falling out of the receptacle. Thus, once the tip is inserted into the receptacle, it may be trapped between the one or more petals and the end of the receptacle.

The first material being harder than the second material may mean that the first material is more rigid, e.g. the first material has a higher resistance to deformation under applied pressure compared to the second material. For example, an elastic modulus of the first material may be greater than an elastic modulus of the second material. In general, the first material may be less flexible whilst the second material may be more flexible (e.g. elastic), such that the second material may be more readily deformable than the first material.

Any suitable combination of first material and second material may be selected, to achieve a suitable hardness of the tip to enable insertion through part of the animal, whilst providing sufficient flexibility of the tip to facilitate insertion of the tip into the female engagement portion. For example, the first material may comprise a hard material such as a metal (e.g. steel, aluminium) or a hard plastic material. The second material may be more flexible, and may include for example a flexible plastic material, rubber, or a foam material.

The first part and/or the second part of the tag may comprise a respective plate. The plate may also be referred to as a flag, and typically has a flat area for displaying identification information. The plate may comprise identification information, e.g. for identifying an animal to which the tag is attached. For example, the first part may comprise a plate which is attached to the female engagement portion, and/or the second part may comprise a plate which is attached to the male engagement portion.

The one or more openings in the body may be located in a base portion of the tip, and a distal end portion of the tip may be formed by the first material of the body. In other words, the second portion of the outer surface of the tip may be located on the base portion of the tip, whilst the first material of the body may be exposed on the outer surface of the tip in the distal end portion. In this manner, the distal end portion of the tip, which may be used for piercing part of the animal, may be formed by the harder first material. The more flexible second material may be located in the base portion of the tip, to enable compression of the base portion during insertion into the female engagement portion. In particular, the base portion of the tip may have a larger cross-sectional area than the distal end portion, such that increasing flexibility of the base portion may facilitate insertion of the tip into the female engagement portion (e.g. as this may enable the larger base portion to be compressed as it is inserted into the female engagement portion). Accordingly, such a structure of the tip may facilitate attaching the tag to the animal.

The base portion of the tip may correspond to a portion where an outer diameter of the tip is the largest. This may enable the tip to be compressed where it has the largest outer diameter, thus facilitating insertion into the female engagement portion. In contrast, the distal end portion may have a smaller outer diameter than the base portion. The distal end portion may have an outer diameter that progressively tapers towards the distal end of the tip.

The distal end portion of the tip may be pointed. In other words, the body may have a pointed distal tip. This may facilitate piercing part of the animal to attach the tag to the animal. The distal end portion of the tip may have a tapered shape, e.g. the tip may taper from the base portion to the pointed tip.

The first portion of the outer surface of the tip may extend from a distal end of the tip to a proximal end of the tip. In this manner, the harder material of the body may extend an entire length of the tip. This may serve to ensure a rigidity of the tip in a longitudinal direction of the tip, which may facilitate piercing the part of the animal with the tip. The distal end of the tip may correspond to an end of the tip which is arranged to first pass through the part of the animal and into the female engagement portion. The proximal end of the tip may be located at an opposite end of the tip relative to the distal end. For example, the base portion mentioned above may be located towards the proximal end of the tip.

The one or more openings may comprise a plurality of openings, and the plurality of openings may be evenly spaced about a longitudinal axis of the tip. In this manner, the openings may be distributed about the longitudinal axis of the tip. As a result, the tip may be compressible at various locations around its perimeter, which may facilitate inserting the tip into the female engagement portion. The plurality of openings may be spaced by portions of the first material of the body, which may serve to maintain a rigidity of the tip in the longitudinal direction, to facilitate piercing the part of the animal with the tip.

The one or more openings may comprise an annular opening that extends around a longitudinal axis of the tip. In this manner, the second portion of the outer surface of the tip may have an annular shape that extends around the longitudinal axis of the tip. As a result, part of the tip may be compressible around its entire permitter (e.g. circumference), which may facilitate inserting the tip into the female engagement portion.

The body may include an internal cavity that is at least partially filled with the second material. This may enhance the tip's ability to flex and be compressed, thus facilitating its insertion into the female engagement part. In other words, the body may be partially hollow, with a portion of the second material located inside the body. Thus, the body may form a rigid outer shell to facilitate piercing the part of the animal, whilst the second material in the internal cavity may provide the body with a degree of flexibility and compressibility. For example, the body may be in the form of a hollow shell which is filled with the second material.

The one or more openings may be in communication with the internal cavity, such that the second material extends continuously from the internal cavity to the one or more openings. In this manner, the second material which is located in the one or more openings and the cavity in the body can be formed as a single part. This may improve an integrity of the tip, as well as facilitate manufacture of the tip. For example, the second material may be formed (e.g. moulded) as a one part, over which the body is arranged to form the tip. In particular, this may enable the second material to be overmoulded onto the first material (or vice versa), which may ensure an accurate fit between the first material of the body and the second material in the internal cavity and the one or more openings. For instance, in some cases, the body may be overmoulded onto the second material. Alternatively, the body may be formed and then the second material may be overmoulded onto the body.

The first material and the second material in the tip may be bonded together. This may improve an integrity and reliability of the tip. In particular, as the tip may typically experience compression and/or bending as it is pressed through the part of the animal and into the female engagement portion, bonding the first and second material's together may avoid the materials from separating when the tag is attached to the animal. Any suitable means of bonding may be used for bonding the first and second materials together. For example, an adhesive may be used to bond the first and second materials together.

The first material and the second material in the tip may be chemically bonded together. This may enable a particularly strong bond between the two materials, thus improving a reliability of the tip and reducing a risk of the two materials separating when the tag is attached to the animal. The first and second materials may be selected to enable chemical bonding between the two.

By way of example, different thermoplastic elastomers (TPEs) may chemically bond together. For instance TPEs of differing grades (e.g. with different levels of hardness) may chemically bond together. Examples of TPEs and other thermoplastics include (but are not limited to) Thermoplastic Polyurethane (TPU), Polybutylene Terephthalate (PBT), Polycarbonates (PC), Acrylonitrile Butadiene Styrene (ABS), and Polyamide (PA). Accordingly, the first material and the second material may be selected from suitable TPE materials that can chemically bond together.

The first material and the second material may correspond to a same material type. In other words, the first material and the second material may have a similar (or same) chemical composition, whilst having a different hardness. This may facilitate chemical bonding between the first material and the second material, thus improving integrity and reliability of the tip. As an example, the first material and the second material may correspond to different grades of a same type of plastic material. Thus, the first material and the second material may both be plastic materials based on the same polymer(s), but which are engineered to have different levels of hardness.

In one example, the first material may be a first TPE material and the second material may be a second TPE material, the first TPE material having a greater hardness than the second TPE material. Thus, the first and second materials may correspond to a same type of plastic (i.e. TPE) whilst having different levels of hardness, such that they can readily be chemically bonded together.

The following is a non-limiting list examples of types of materials that can be used for the first material and/or the second material: Polycarbonate (PC), Polypropylene (PP), Polystyrene (PS), Acrylonitrile Butadiene Styrene (ABS), Cyclic Olefin Copolymer (COC), Cyclic Olefin Polymer (COP), Acrylonitrile Styrene Acrylate (ASA), Styrene Acrylonitrile Resin (SAN), Polybutylene Terephthalate (PBT).

A proximal end of the tip may be formed by the first material of the body, and the female engagement portion may be configured to engage the proximal end of the tip when the tip is received in the female engagement portion, to thereby retain the tip in the female engagement portion. In this manner, the female engagement portion can retain the tip via engagement with the harder first material of the body when the tip is received in the female engagement portion. This may improve a stability of the engagement between the proximal end of the tip and the female engagement portion, which may ensure that the tip is reliably retained in the female engagement portion.

As an example, the proximal end of the tip may comprise a ring of the first material of the body, where the ring is centred about a longitudinal axis of the tip. In this manner, the proximal end of the tip can be supported against the female engagement portion around its longitudinal axis, which may improve a stability and reliability with which the tip is retained in the female engagement portion.

Where the female engagement portion includes an opening, with one or more petals arranged around an edge of the opening, the proximal end of the tip may be configured to engage (abut) a blocking surface on the one or more petals when the tip has been inserted through the opening, to block the tip from being withdrawn from the opening.

The male engagement portion may further comprise a stem, the tip being located at an end of the stem. In this manner, after the tip is inserted through the part (e.g. ear) of the animal, the stem may pass through the part of the animal. In other words, when the tag is attached to the animal, the stem may pass (e.g. extend) through the part of the animal. The stem may have an outer diameter that is smaller than a maximum outer diameter of the tip. In this manner, the stem may readily fit through a hole pierced by the tip. A plate may be connected to an end of the stem opposite the end where the tip is located. This may prevent the stem from falling through the hole once the tag is attached to the animal.

The stem may be formed of the second material. In this manner, the stem may be relatively flexible relative to the harder first material of the body. This may enable the stem to flex and bend a certain amount, which may allow a small amount of relative movement between the first and second parts of the tag when the tip is received in the female engagement portion. This degree of flexibility may reduce a risk of the stem breaking when the tag is attached to the animal, which may improve a reliability with which the tag is secured to the animal. This flexibility in the stem section may serve to reduce a risk of the hole in the animal (e.g. through its ear) getting bigger, which may reduce a risk of infection.

The second material in the stem and the second material in the tip may be integrally formed. In other words, the stem and the second material in the tip (e.g. in the one or more openings and the internal cavity if present) may be formed as a single part. This may improve an integrity of the male engagement portion, as well as simplify a manufacture of the male engagement portion. For example, the stem and the second material in the tip may be moulded as a single part. The first material of the body may then be overmoulded onto the second material to form the male engagement portion. Alternatively, the body may first be formed of the first material, and the second material (including the stem) may be overmoulded onto the body.

The second part may further comprise a plate formed of the second material, the stem extending from the plate. This may simplify manufacture of the second part, as the stem and the plate may be formed (e.g. moulded) as a single part. Moreover, by making the plate of the second material, the plate may be relatively flexible which may reduce a risk of the plate breaking once it is attached to the animal.

The first part may further comprise a plate, wherein the female engagement portion is formed of a harder material than the plate. Making the female engagement portion of a harder material may serve to ensure that the tip can be reliably retained in the female engagement portion. On the other hand, making the plate of a less hard (e.g. more flexible) material may enable the plate to bend and flex, which may reduce a risk of the plate breaking when the tag is attached to the animal. For example, the one or more petals of the female engagement portion mentioned above may be formed of the harder material. The material of the plate in the first part may be the same material as that used for the plate in the second part (i.e. the second material).

The female engagement portion may comprise (e.g. be formed of) a material that is harder than a material of the stem of the male engagement portion. For example, where the stem is made of the second material, the female engagement portion may comprise a material that is harder than the second material. In this manner, if a person attempts to remove the tip from the female engagement portion, the stem may be more likely to break than the female engagement portion. Accordingly, the tag may be rendered unusable if tampering with the tag is attempted. In particular, this may prevent the tag from being detached from one animal and reapplied to another animal.

In one example, the female engagement portion may be formed (e.g. moulded) as a single integral part. The plate of the first part may then be formed as another part, with the female engagement portion and the plate being subsequently assembled together. In some cases, the plate of the first part may be overmoulded onto the female engagement portion (or vice versa), to ensure a tight connection between the two.

According to a second aspect of the invention, there is provided a method of manufacturing an animal identification tag, the method comprising: forming a first part of the tag, the first part of the tag comprising a female engagement portion; forming a second part comprising a male engagement portion having a tip, wherein the female engagement portion is configured to receive and retain the tip; wherein the tip comprises a body formed of a first material, the body including one or more openings that are filled with a second material, such that a first portion of an outer surface of the tip is formed by the first material, and a second portion of the outer surface of the tip is formed by the second material; and wherein the first material is harder than the second material.

The method of the second aspect may be used to make the tag of the first aspect. Accordingly, any features discussed above in relation to the first aspect of the invention may be shared with the second aspect of the invention (and vice versa).

The tip may be formed using an overmoulding process. Thus, the tip may be formed by overmoulding the first material of the body onto the second material, or by overmoulding the second material onto the first material of the body. This may simplify a manufacture of the male engagement portion, and ensure a tight fit between the first and second materials, thus improving an integrity of the tip.

In some cases, the tip may be formed by overmoulding the first material of the body onto the second material. For example, a portion of the tip may be formed (e.g. by a moulding process) with the second material. The body may then be formed by overmoulding the first material onto the portion of the second material.

In other cases, the second material may be overmoulded onto the first material of the body. For example, the body may be formed (e.g. by a moulding process) with the first material. The second material may then be formed by overmoulding the second material onto the first material of the body. Where the stem and the plate are formed of the second material, the stem and plate may be formed as part of the same overmoulding process.

The first part of the tag may be formed, for example, using processes as discussed in relation to the first aspect of the invention.

Herein, the longitudinal axis of the tip of the male engagement portion may refer to a direction along which the tip is inserted into the female engagement portion. In other words, the longitudinal axis may extend from a base of the tip to the distal end of the tip.

Herein, the terms “animal identification tag” and “tag” are used interchangeably.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1a show a schematic plan view of a first tag part of a tag according to an embodiment of the invention;

FIG. 1b is a schematic cross-sectional diagram of the first part of the tag;

FIG. 2a shows a schematic plan view of a second part of the tag;

FIG. 2b shows a schematic side view of the second part of the tag;

FIG. 2c is a schematic cross-sectional diagram showing an expanded view of a portion of the second part of the tag;

FIGS. 3a and 3b show schematic perspective views of a body that is part of a male engagement portion of the second part of the tag;

FIG. 4a shows a schematic perspective view of the tag where the first part and the second part are attached together; and

FIG. 4b is a schematic cross-sectional diagram of the tag where the first part and the second part are attached together.

### DETAILED DESCRIPTION OF THE INVENTION

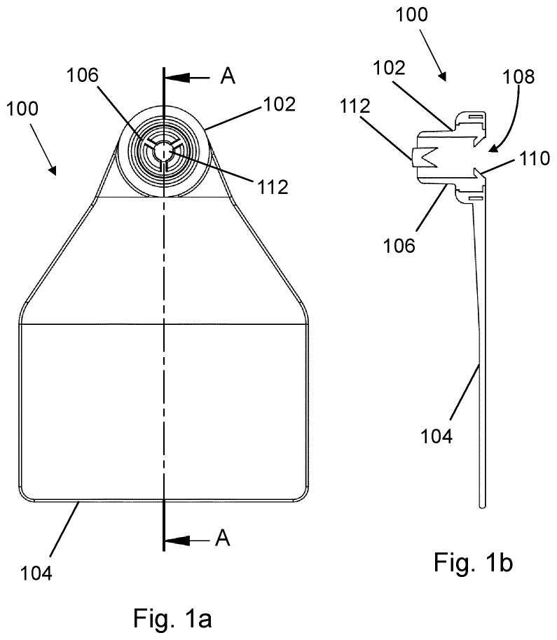

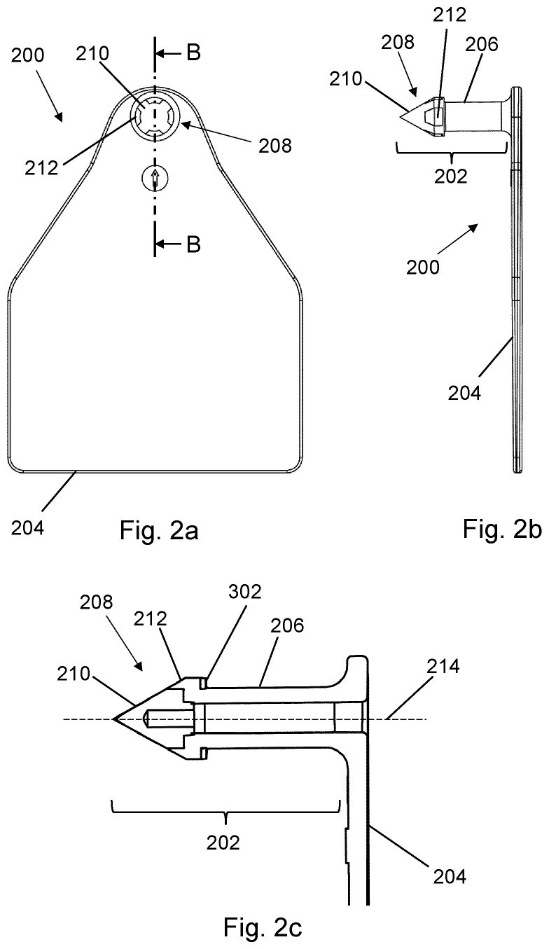

An animal identification tag according to an embodiment of the invention will be described with reference to FIGS. 1-4. FIGS. 1a and 1b depict a first part 100 of the tag, whilst FIGS. 2a, 2b and 2c depict a second part 200 of the tag. The tag may be attachable to a part of an animal. For example, the tag may be an ear tag for attachment to an ear of the animal.

FIG. 1a shows a schematic plan view of the first part 100, whilst FIG. 1b shows a schematic cross-sectional view of the first part 100, corresponding to the A-A plane shown in FIG. 1a. The first part 100 of the tag includes a female engagement portion 102 which is connected to a plate 104. The plate includes a substantially planar area on which identification information (e.g. name, identification number) can be placed. For example, the identification information may be printed, etched or otherwise affixed on to the plate 104, to enable identification of an animal once the tag has been applied to the animal.

FIG. 2a shows a schematic plan view of the second part 200, whilst FIG. 2b shows a schematic side view of the second part 200. The second part 200 of the tag includes a male engagement portion 202 which is connected to a plate 204. In more detail, the male engagement portion 202 includes a stem 206 which is connected at one end to the plate 204, with a tip 208 of the male engagement portion 202 being located at a second, opposite end of the stem 206. The male engagement portion 202 extends in a longitudinal direction substantially normal to the plate 204. The plan view of FIG. 2a looks towards the second part 200 along the longitudinal direction, such that only the tip 208 of the male engagement portion 202 can be seen in FIG. 2a. Similarly to the plate 104 of the first part 100, the plate 204 of the second part 200 includes a substantially planar area on which identification information (e.g. name, identification number) can be placed. For example, the identification information may be printed, etched or otherwise affixed on to the plate 204, to enable identification of an animal once the tag has been applied to the animal.

The female engagement portion 102 is configured to receive the tip 208 of the male engagement portion 202. In particular, the female engagement portion 102 includes a receptacle 106 which is arranged (shaped) to receive the tip 208, i.e. so that the tip 208 can be fully inserted into the receptacle 106. The female engagement portion 102 is further configured to retain the tip 208 in the receptacle 106 once the tip 208 has been inserted into the receptacle 106. In particular, the receptacle 106 includes an opening 108 via which the tip 208 is insertable to the receptacle 106, with a plurality of petals (or protrusions) 110 arranged around the opening 108. The petals 110 are shaped so as to allow the tip 208 to be inserted into the receptacle 106 via the opening 108, but to prevent the tip 208 from being withdrawn from the receptacle 106 once the tip 208 has been fully inserted, as discussed in more detail below.

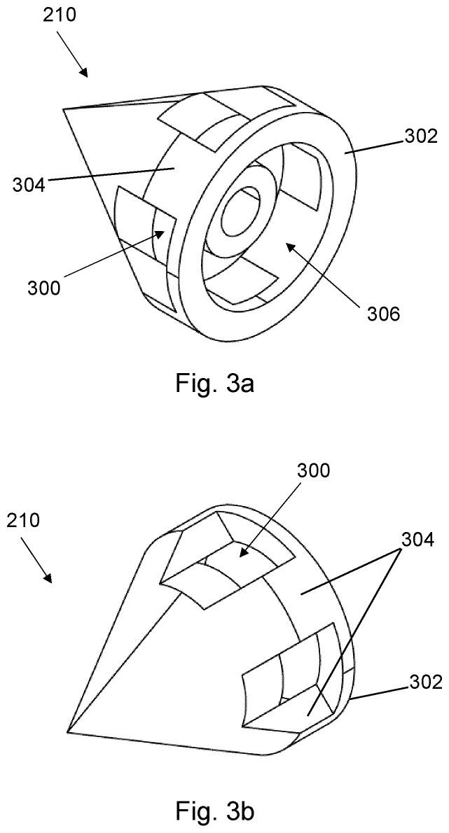

FIG. 2c is a schematic cross-sectional diagram showing an expanded view of the male engagement portion 202. The cross-sectional view of FIG. 2c is taken along the plane B-B shown in FIG. 2a. The tip 208 of the male engagement portion 202 is formed of two materials having different levels of hardness. In more detail, the tip 208 includes a body 210 formed of a first material. Perspective views of the body 210 on its own are shown in FIGS. 3a and 3b. The body 210 includes a plurality of openings 300 formed in an outer surface of the body 210. The openings 300 are filled with a second material 212, such that a first portion of an outer surface of the tip 208 is formed by the first material of the body 210, and a second portion of the outer surface of the tip 208 is formed by the second material 212 filling the openings 300. The second material 212 filling the openings 300 lies flush with the outer surface of the body 210, such that the tip 208 has a smooth outer surface. The first material of the body 210 is harder than the second material 212. In other words, the first material is more rigid (e.g. less flexible) than the second material 212.

The openings 300 in the body 210 are formed in a base portion of the tip 208, i.e. in a portion of the tip 208 located towards a proximal end of the tip 208 which is connected to the stem 206. As can be seen, the tip 208 is widest at its proximal end, and tapers to a pointed tip at its distal end. For instance, as shown, the tip 208 may have a substantially conical shape. Thus, as the openings 300 are located in the base portion of the tip 208, they are located in the portion of the tip 208 having the largest outer diameter. In this manner, portions of the outer surface of the tip 208 where the tip 208 is widest are formed of the second material 212. Furthermore, the openings 300 are evenly spaced around a longitudinal axis 214 of the tip 208, such that the second material 212 is exposed at evenly spaced locations around the longitudinal axis 214 of the tip 208. The base portion of the tip 208 has a larger outer diameter than the stem 206, i.e. a maximum outer diameter of the tip 208 is greater than a maximum outer diameter of the stem 206. A distal end portion of the tip 208 is formed by the body 210. In other words, the outer surface of the tip towards its distal end is formed by the first material of the body 210. The distal end portion has a substantially conical shape which tapers from the base portion to the pointed distal end of the tip 208.

The body 210 extends an entire length of the tip 208, i.e. from the proximal end to the pointed distal end of the tip 208. In particular, as shown in FIGS. 3a and 3b, the body 210 includes a ring portion 302 which defines a proximal end of the tip 208. The body 210 includes a set of branches (connecting elements) 304 extending between the openings 300 and which connect the ring portion 302 to the rest of the body 210. The ring portion 302 is centred about the longitudinal axis 214 of tip 208, and acts as a rigid surface against which the petals 110 abut when the tip 208 is inserted into the receptacle 106 of the female engagement portion 102, in order to retain the tip 208 in the receptacle 106.

As can be seen in FIG. 3a, the body 210 has an internal cavity 306, i.e. the body 210 is partially hollow. The cavity 306 is arranged in the base portion of the tip 208, and is defined within a part of the body 210 including the branches 304 and the ring portion 302. The ring portion 302 defines an opening into the internal cavity 306. Moreover, the openings 300 in the body 210 are in communication with the internal cavity 306, i.e. the openings 300 are formed in a sidewall of the body 210 that defines the internal cavity 306. This structure of the body 210 enables the stem 206 of the male engagement portion 202 to be integrally formed with the second material 212 in the tip 208. In particular, as shown in FIG. 2c, the material of the stem 206 passes through the opening of the ring portion 302 into the internal cavity 306, and into the openings 300 to form part of the outer surface of the tip 208. Thus, the second material 212 in the tip 208 and the stem 206 can be formed of the same material and can be manufactured as a single integral part. Further, as illustrated in FIG. 2c, the stem 206 and the plate 204 may be formed as continuous piece of material. Accordingly, the plate 204, the stem 206 and the second material 212 of the tip 208 may all be integrally formed as a single part. In the example shown in FIG. 2c, the stem 206 is hollow. This may enhance a flexibility of the stem 206. However, in other examples, the stem 206 need not necessarily be hollow.

In alternative embodiments (not shown), instead of a plurality of windows spaced around the longitudinal axis 214, the body 210 may include a single annular opening extending around the longitudinal axis 214. Then, instead of having branches 304 which are exposed on the outer surface of the tip 208, the body 210 may include one or more internal supports (e.g. extending within the internal cavity 306) for connecting the ring portion 302 to the rest of the body 210.

As mentioned above, the first material of the body 210 is harder than the second material 212. In use, the harder first material of the body 210 may serve to push through (pierce) the part (e.g. ear) of the animal to which the tag is to be attached, whilst the more flexible second material 212 may enable parts of the outer surface of the tip 208 to be compressed, to facilitate insertion of the tip 208 into the female engagement portion 102. Accordingly, any suitable combination of materials for achieving these effects may be used. For example, the first material may be a metal (e.g. steel, aluminium) whilst the second material may be a more flexible plastic. As another example, plastics having different levels of hardness may be used for the first and second materials. The body 210 and the second material 212 may be bonded together, to ensure integrity of the tip 208. For instance, an adhesive may be applied between the body 210 and the second material 212. Additionally or alternatively, chemical bonding between the two materials may be used, e.g. the two materials may be selected so that they can be chemically bonded together.

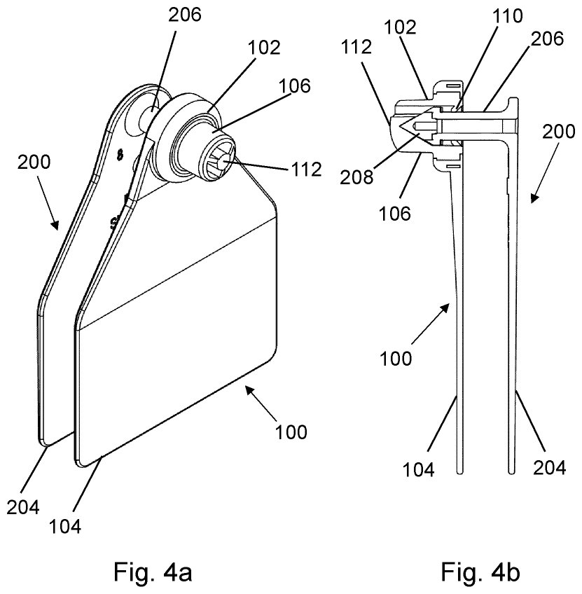

An assembly of the first part 100 and the second part 200 of the tag will now be described with reference to FIGS. 4a and 4b. FIG. 4a shows a schematic perspective view of the assembled tag, i.e. where the tip 208 of the male engagement portion 202 is engaged in the female engagement portion 102. FIG. 4b shows a schematic cross-sectional view of the assembled tag.

To attach the tag to an animal, the male engagement portion 202 of the second part 200 may be passed through the part (e.g. ear) of the animal to which the tag is to be attached. Here, the pointed distal end of the tip 208 and the harder first material of the body located in the distal end portion of the tip 208 may facilitate piercing the part of the animal. The first part 100 may be arranged on an opposite side of the part of the animal, so that the tip 208 of the male engagement portion 202 can be inserted into the female engagement portion 102. In this manner the part (e.g. ear) of the animal may be sandwiched between the first part 100 and the second part 200 of the tag, with the stem 206 passing through the part of the animal. To insert the tip 208 into the female engagement portion 102, the tip 208 is pressed into the opening 108. The narrower distal end portion of the tip 208 may pass between the petals 110. When the wider base portion of the tip 208 reaches the petals 110, portion of the outer surface of the tip 208 formed by the second material 212 may bend and/or compress, to enable the tip 208 to be fully inserted into the receptacle 106. In some cases, the harder first material of the body 210 may also deflect the petals 110, to facilitate insertion of the tip 208.

As shown in FIG. 4b, once the tip 208 is fully inserted into the receptacle 106, the petals 110 act to block the tip 208 from being withdrawn from the receptacle 106. In particular, the petals 110 include a blocking surface which is arranged to abut the ring portion 302 of the body 210 if the second part 200 is pulled away from the first part 100, to thereby prevent the tip 208 from being withdrawn from the receptacle 106. Additionally, the receptacle 106 includes a blocking element 112 which acts to close an end of the receptacle 106 opposite its opening 108. The blocking element 112 is arranged to prevent the tip 208 from falling out the end of the receptacle 106. Thus, once the tip 208 has been inserted into the receptacle 106, it is effectively trapped within the receptacle 106. This may prevent tampering with the tag, as it may avoid the tag being removed from one animal and subsequently used on another animal. Additionally, if the tip 208 breaks off the stem 206, the tip 208 will remain trapped within the receptacle 106, thus preventing use of the first part 100 on another animal.

The female engagement portion 102 may be formed of a material that is harder than the material of the stem 206, i.e. that is harder than the second material. In particular, the petals 110 may be formed of a material that is harder than the second material. This may make the stem 206 and/or the connection between the stem 206 and the tip 208 more likely break than the petals 110 and receptacle 106 if tampering with the tag is attempted. Accordingly, if a person attempts to remove the tip 208 from the receptable 106, this may cause the stem 206 to become separated from the tip 208, with the tip 208 remaining trapped in the receptacle 106. This may prevent both parts of the tag from being reused on another animal.

An example method of manufacturing the tag will now briefly be described. The first part 100 of the tag may be manufactured by forming the female engagement portion 102 via a suitable moulding process (e.g. injection moulding). In particular, the female engagement portion 102, including the receptacle 106, petals 110 and blocking element 112 may be formed as a single part. As noted above, the female engagement portion 102 may be formed of a relatively hard material. As an example, the female engagement portion 102 may be formed of a hard plastic such as (but not limited to) Nylon. The plate 104 of the first part 100 may then be formed via another moulding process. In some cases, the plate 104 may be overmoulded onto the female engagement portion 102, to ensure a strong connection between the plate 104 and the female engagement portion 102. The plate 104 may be made of a material that is more flexible than the female engagement portion 102.

The second part 200 of the tag may be manufactured by first forming the body 210 of the first material, e.g. using a suitable moulding process such as injection moulding. The plate 204, the stem 206 and the second material 212 of the tip 208 may be formed as a single part. In other words, the plate 204, the stem 206 and the second material 212 of the tip 208 may be integrally formed as a single piece of material. This may be achieved using a suitable moulding process, such as injection moulding. In particular, the plate 204, the stem 206 and the second material 212 of the tip 208 may be formed by overmoulding the second material onto the first material of the body 210. This may result in a tight connection between the body 210 and the second material 212 in the tip. Alternatively, in other manufacturing methods, the first material may be overmoulded onto the second material. In other words, the plate 204, the stem 206 and the second material 212 of the tip 208 may be initially formed as a single piece of material, and then first material of the body 210 may be overmoulded onto the second material 212 of the tip 208.

In some cases, the first material of the body 210 and the second material 212 (also in the stem 206 and the plate 204) may correspond to a same material type, whilst having different hardness levels. For instance, the first material and the second material may correspond to different grades of a same type of plastic material. In a particular example, the first material of the body 210 may be a first thermoplastic elastomer (TPE) material and the second material may be a second TPE material, the first TPE material having a greater hardness than the second TPE material. In this manner, the first material and the second material may be chemically bonded together, thus improving a strength and integrity of the tip 208. The plate 104 of the first part may be also be made of the second material. The chemical bond between the first material and the second material may form, for example, during the overmoulding process mentioned above. In some cases, bonding agents may be added to TPEs to further improve a strength of the chemical bond. As a specific example, the first material may comprise one of Elastollan® 1283D, Elastollan® 1278D, or Hytrel® 8238, whilst the second material may comprise one of Elastollan® 1195A, Elastollan® 1185A, or Hytrel® 4056, all of which are examples of suitable TPE materials.

It should be noted that other techniques for manufacturing and assembling the tag parts may be used instead of the specific examples described above.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. An animal identification tag comprising:
a first part comprising a female engagement portion; and
a second part comprising a male engagement portion having a tip, wherein the female engagement portion is configured to receive and retain the tip;
wherein the tip comprises a body formed of a first material, the body including one or more openings that are filled with a second material, such that a first portion of an outer surface of the tip is formed by the first material, and a second portion of the outer surface of the tip is formed by the second material;
wherein the first material is harder than the second material.

2. An animal identification tag according to claim 1, wherein the one or more openings are located in a base portion of the tip, and wherein a distal end portion of the tip is formed by the first material of the body.

3. An animal identification tag according to claim 2, wherein the distal end portion of the tip is pointed.

4. An animal identification tag according to claim 1, wherein the first portion of the outer surface of the tip extends from a distal end of the tip to a proximal end of the tip.

5. An animal identification tag according to claim 1, wherein the one or more openings comprises a plurality of openings, and the plurality of openings are evenly spaced about a longitudinal axis of the tip.

6. An animal identification tag according to claim 1, wherein the one or more openings comprises an annular opening that extends around a longitudinal axis of the tip.

7. An animal identification tag according to claim 1, wherein the body includes an internal cavity that is at least partially filled with the second material.

8. An animal identification tag according to claim 7, wherein the one or more openings are in communication with the internal cavity whereby the second material extends continuously from the internal cavity to the one or more openings.

9. An animal identification tag according to claim 1, wherein the first material and the second material in the tip are bonded together.

10. An animal identification tag according to claim 9, wherein the first material and the second material are chemically bonded together.

11. An animal identification tag according to claim 1, wherein the first material and the second material correspond to a same material type.

12. An animal identification tag according to claim 1, wherein a proximal end of the tip is formed by the first material of the body, and wherein the female engagement portion is configured to engage the proximal end of the tip when the tip is received in the female engagement portion, to thereby retain the tip in the female engagement portion.

13. An animal identification tag according to claim 1, wherein the male engagement portion further comprises a stem, the tip being located at an end of the stem, and wherein the stem is formed of the second material.

14. An animal identification tag according to claim 13, wherein the second material in the stem and the second material in the tip are integrally formed.

15. An animal identification tag according to claim 13, wherein the second part further comprises a plate formed of the second material, the stem extending from the plate.

16. An animal identification tag according to claim 1, wherein the first part further comprises a plate, wherein the female engagement portion is formed of a harder material than the plate.

17. A method of manufacturing an animal identification tag, the method comprising:
forming a first part of the tag, the first part of the tag comprising a female engagement portion;
forming a second part comprising a male engagement portion having a tip, wherein the female engagement portion is configured to receive and retain the tip;
wherein the tip comprises a body formed of a first material, the body including one or more openings that are filled with a second material, such that a first portion of an outer surface of the tip is formed by the first material, and a second portion of the outer surface of the tip is formed by the second material; and
wherein the first material is harder than the second material.

18. A method according to claim 17, wherein the tip is formed by overmoulding the first material of the body onto the second material, or by overmoulding the second material onto the first material of the body.
